(19) United States
(12) Patent Application Publication
(10) Pub. No.: US 2025/0064054 A1
(43) Pub. Date: Feb. 27, 2025

(54) PEST REPELLENT BUFFER MATERIALS AND DEVICES

(71) Applicant: Michael Quin, Kirkland, WA (US)

(72) Inventor: Michael Quin, Kirkland, WA (US)

(21) Appl. No.: 18/813,970

(22) Filed: Aug. 23, 2024

Related U.S. Application Data
(60) Provisional application No. 63/578,562, filed on Aug. 24, 2023.

(51) Int. Cl. A01N 25/10; A01N 25/34; A01N 65/00; A01P 17/00

(52) U.S. Cl. CPC A01N 25/10; A01N 25/34; A01N 65/00; A01P 17/00

(57) ABSTRACT

A functional polymer, a repellent buffer including the same, and methods of making and using such a repellent buffer are provided. In example embodiments, a functional polymer includes a polymer substrate, and a pest repellent agent dispersed within said polymer substrate. The polymer substrate is configured to allow the insect repellent agent to be released therefrom.

### CROSS-REFERENCE TO RELATED APPLICATION

This patent document claims the benefits and priority of U.S. Provisional Application No. 63/578,562 entitled “PEST REPELLENT BUFFER MATERIALS AND DEVICES” and filed Aug. 24, 2023, which is incorporated herein by reference in its entirety.

### TECHNICAL FIELD

The present technology is directed to pest repellent buffer materials and devices, and methods of making or using the same.

### BACKGROUND

Pest control is a common practice in various settings. Pests, ranging from insects and rodents to fungi and weeds, have long threatened food security, personal and public health, and economic interests.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIGS. 1-5 show exemplary use cases of one or more repellent buffers installed at or in a vicinity of a doorway according to some embodiments of the present document.

FIGS. 6A though 6E show examples of exterior installations of repellent buffers according to some embodiments of the present document.

FIGS. 7 through 9B show examples of interior installations of repellent buffers according to some embodiments of the present document.

FIGS. 10-14 show examples of components of a kit according to some embodiments of the present document.

FIG. 15 illustrates an example of a process for making a repellent buffer according to some

embodiments of the present document.

FIGS. 16-23 illustrate examples of various steps of a process for making a repellent buffer according to some embodiments of the present document.

FIGS. 24, 25, and 26A through 26E illustrate various example repellent buffers made according to some embodiments of the present document.

FIG. 26F illustrate an example mold including a pest repellent agent configured repellent buffer according to some embodiments of the present document.

FIG. 27 illustrates an example of a process for using a repellent buffer according to some embodiments of the present document.

### DETAILED DESCRIPTION

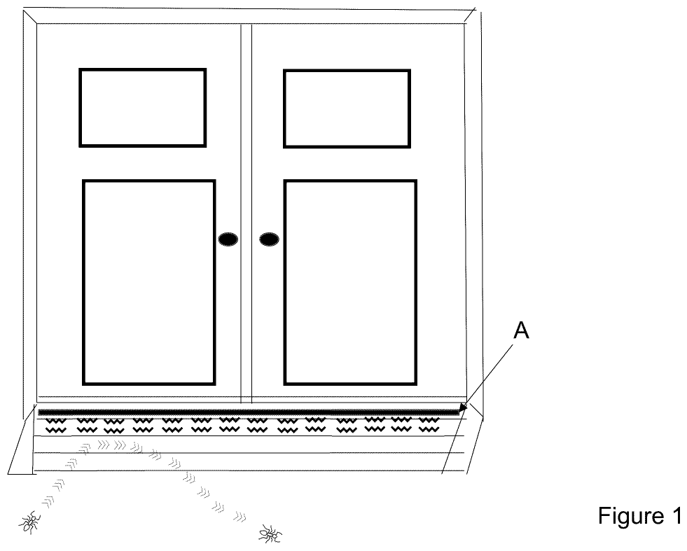

The disclosure provides functional polymer including a pest repellent, products including the same, and methods of making or using the same. Specific details of several embodiments of the present technology are described herein with reference to FIGS. 1 through 27. The present technology, however, can be practiced without some of these specific details. In some instances, well-known compositions and techniques often associated pest repulsion and/or functional polymer, and the like, have not been shown in detail so as not to obscure the present technology. The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements can be arbitrarily enlarged to improve legibility. Component details can be abstracted in the Figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present technology.

Needs in pest control may rise due to one or more factors including, e.g., changing climate conditions, rapid increase of pest populations, augmenting of human infection by certain pests, expansion of integrated pest management (IPM), global pandemic resulted in an increasing awareness of pest infestation hazards and implementation of hygiene, and/or rising urbanization and population.

Some embodiments of the present documents relate so a functional polymer, or a repellent buffer including such a functional polymer. The functional polymer may include a pest repellent agent dispersed in a polymer substrate. The pest repellent agent may include one or more emission compounds that may be volatile. The pest repellent agent may include one or more natural extracts (e.g., one or more natural oils). A natural extract may exhibit repellent function over one or more pests. Examples of applicable natural extracts include at least one of peppermint oil, lemongrass oil, lavender oil, rosemary oil, basil, lemon, eucalyptus oil, lemon eucalyptus, clove oil, lemon, patchouli, sage, spearmint, vetiver, tea tree oil, cedarwood oil, citronella oil, orange oil, cinnamon oil, thyme oil, garlic extract, or neem oil, or a combination thereof. The polymer substrate may include silicone. By adjusting the ratio of natural oils (for example: increasing the volume of natural cinnamon oil as a single oil dispersed in a polymer substrate, or in combination with other natural oils, e.g.,—peppermint oil) a desired product stickiness may be achieved that may be persistent and enhance the pest repelling capabilities. Merely by way of example, it has been observed that spiders and ants have shown consistent behavior to avoid a pest repellent buffer with a sticky texture in addition to the odor emission.

The polymer substrate may be configured to allow the one or more natural extracts dispersed therein to be released over time such that the functional polymer (or a repellent buffer including such functional polymer) may exhibit a persistent repellent function. In some embodiments, the polymer substrate is configured to allow the insect repellent agent to be released therefrom at a (substantially) constant release rate over a period of time (e.g., a few hours, one or more days, one or more weeks, one or more months). As used herein, a constant release rate over a time period may indicate that the change in the release rate over the time period may be below a threshold in the form of an absolute value or a relative value (e.g., 5%, 10%, or 20% of a reference value). In some embodiments, the polymer substrate is configured to allow the insect repellent agent to be released therefrom at a variable release rate that relates to and/or changes with, an external stimulus or condition. Examples of the external stimulus or condition include at least one of heat, light, moisture, a mechanical stress, or the like, or a combination thereof. For example, the functional polymer may release the natural extract(s) dispersed therein at a first release rate at a first room temperature, and at a second, different release rate at a second, different room temperate. In one example implementation, the first release rate is lower than the second release rate when the first room temperature is lower than the second room temperature; such a variable release rate of the natural extract(s) may improve the life of the repellent function of the function polymer without compromising the effect thereof, considering that pests may be more active and/or abundant when it is warmer (e.g., summer vs. winter). The release rate of a natural extract may relate to a property of the polymer substrate (e.g., a filler material of the polymer substrate, the texture of the polymer substrate), a property of the natural extract (e.g., a molecule size of the natural extract), or the like, or a combination thereof. Accordingly, a desired release rate of a natural extract may be achieved by adjusting, e.g., the property of the polymer substrate.

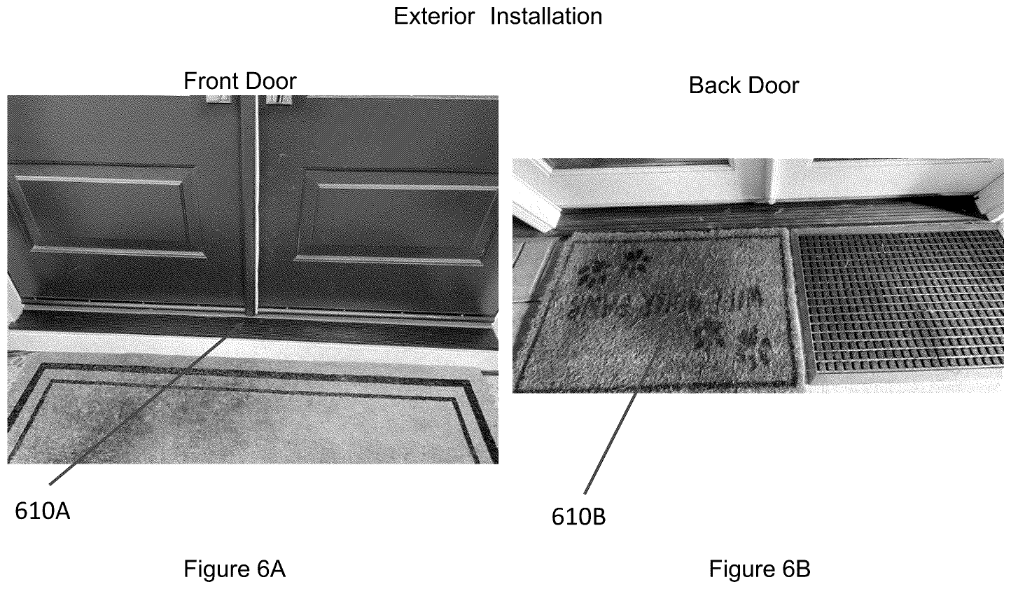

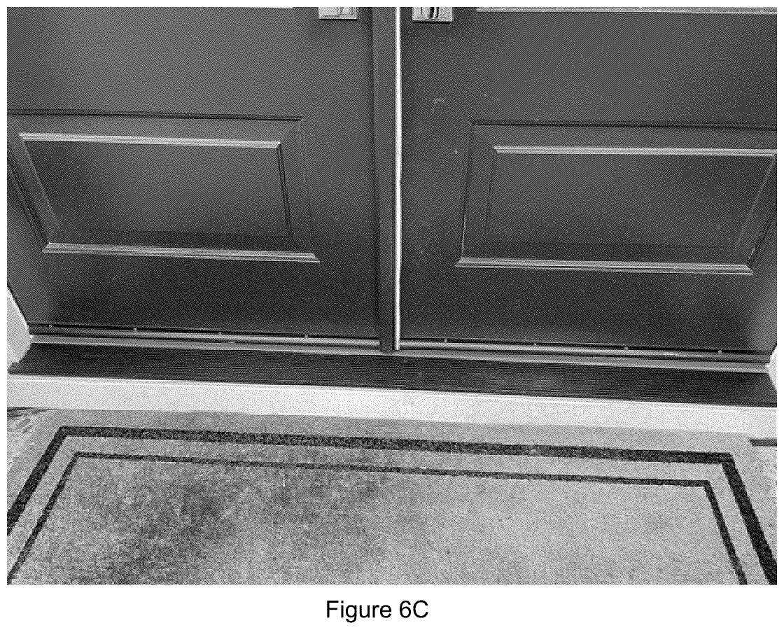

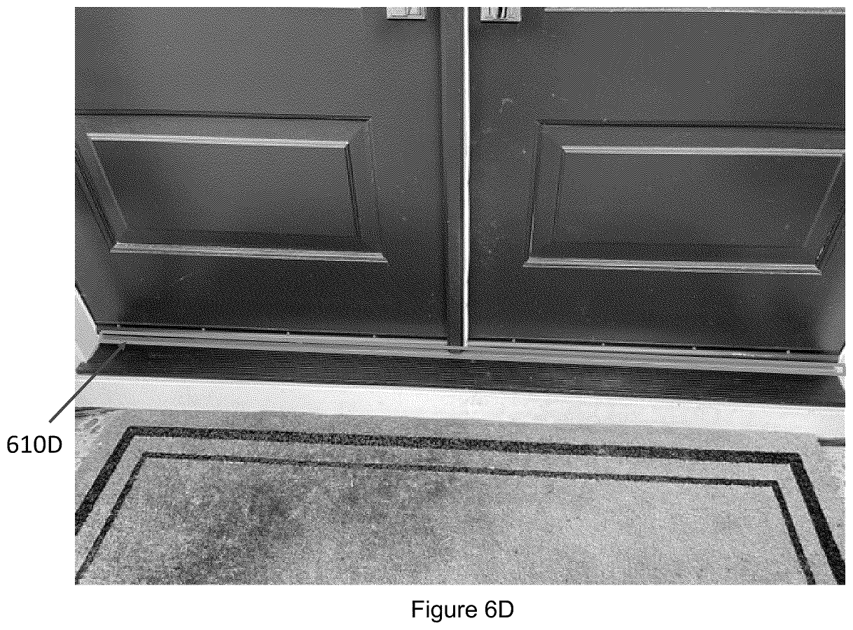

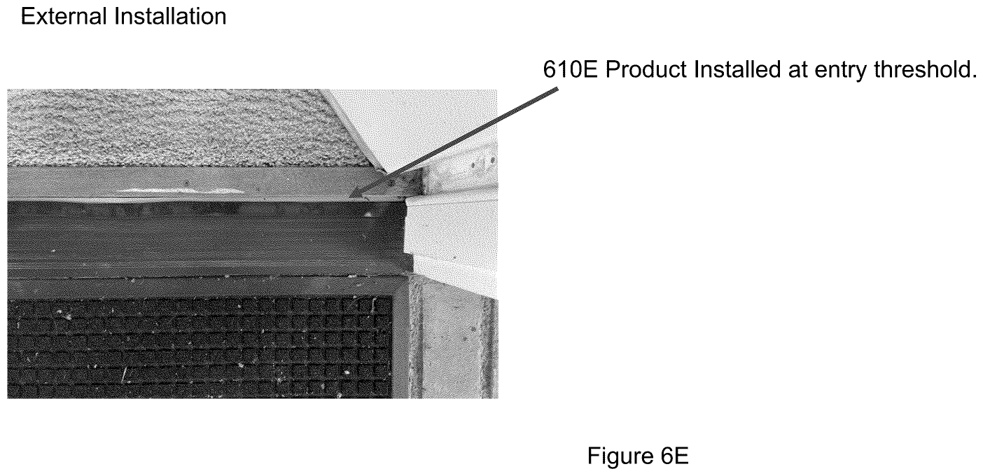

The repellent buffer, as well as the functional polymer, may have at least one of the properties including being non-toxic, flexible, odor-free, soft, clear, or the like, or a combination thereof. For example, the repellent buffer may have a color of choice (e.g., a color that matches a door, a floor, carpet, etc., where it is installed). As another example, the repellent buffer may be odor-free or have a scent of choice. As a further example, the repellent buffer may be clear or opaque. As still a further example, the repellent buffer may include one or more natural extracts selected based on where it is used or specific pests to be repelled. The repellent buffer may have the shape of a strip, a board, etc. The repellent buffer may have one or more other functions than pest repulsion. For example, the repellent buffer may also function as a weather strip (e.g., garage door weather strips, door or window applications), a door sweep, caulking, gap/crack filling, etc., to provide waterproofing, air sealing, noise reduction, aesthetics, or the like, or a combination thereof. As another example, the functional polymer may be used to make hanging decorative strips (or a shape other than a strip). As a still further example, a functional polymer, a repellent buffer including a functional polymer, or a pest repellent agent, may be configured as or incorporated into another object, e.g., a decorative or non-decorative mold, a container, etc., and placed where needed. See, e.g., FIGS. 6A-8 and 26B-26F.

One or more physical characteristics of a functional polymer or a repellent buffer can be customized to suit specific applications, ranging from commercial to domestic use. Examples of adjustable features may include shape, dimension, appearance, surface area, texture, porosity, integration features (e.g., attachment points, grooves, or other features to facilitate integration with existing structures or complementary pest control systems), or the like, or a combination thereof.

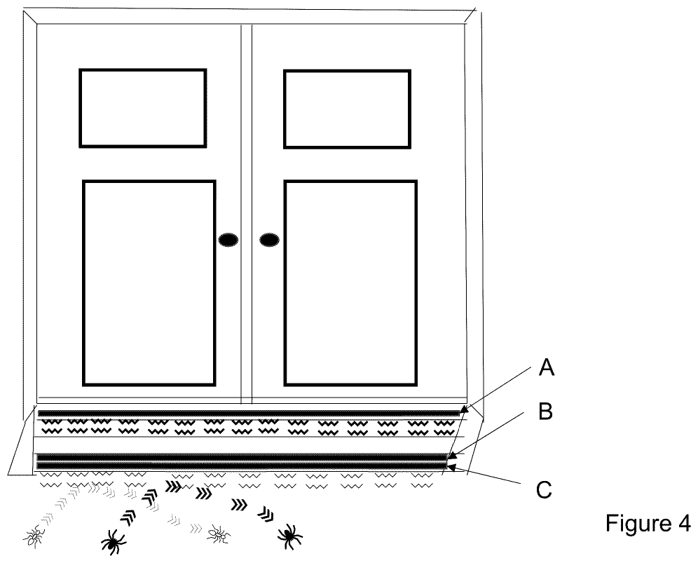

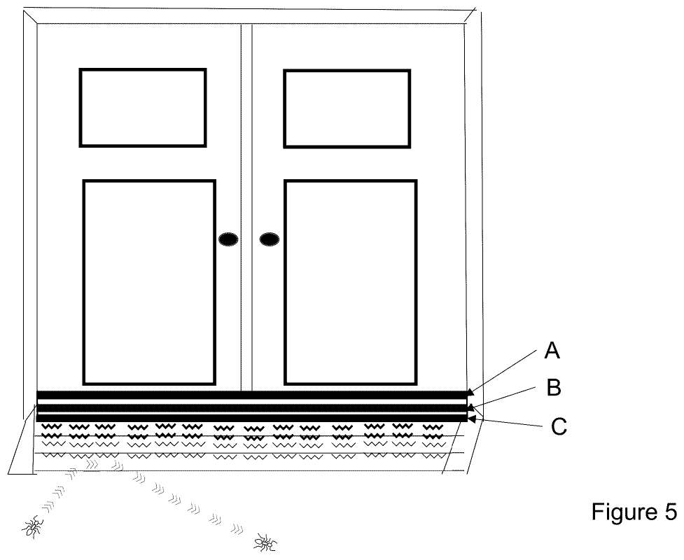

In some embodiments, one repellent buffer may be installed at a location (e.g., at or in a vicinity of a doorway). In some embodiments, multiple repellent buffers may be installed in which the multiple repellent buffers may include a same natural extract or different natural extracts. In some embodiments, adjacent repellent buffers of some of the multiple repellent buffers may be spaced by a distance that is different from adjacent repellent buffers of the others of the multiple repellent buffers. See, e.g., FIG. 4 in which the distance between repellent buffers A and B is different from the distance between repellent buffers B and C. In some embodiments, some or all of the multiple repellent buffers may be equally spaced. See, e.g., the three repellent buffers A, B, and C in FIG. 5.

The functional polymer, as well as the repellent buffer including the functional polymer, may afford technical benefits including effective repulsion of pests from entering an establishment, being safe for use around humans, pets, and food, discrete, easy to install, and environmentally friendly and sustainable. For example, the functional polymer, as well as the repellent buffer, is non-toxic and odor-free. It does not harm beneficial insects. As used herein, an item (e.g., a functional polymer, a repellent buffer) being “odor-free” may indicate that the item does not emit a noticeable odor to humans or certain non-target organisms, such as beneficial insects. This characteristic may allow for effective pest control without harming beneficial insects or disturbing human occupants. The selective repellent effect may be achieved through one or more mechanisms including compound specificity, concentration gradient, passive environmental responsiveness, or the like, or a combination thereof.

The compound specificity may allow the interaction of a released compound with one or more specific olfactory receptors found in a target pest species while reducing or minimizing interaction with those of a non-target species (e.g., beneficial insects of a species present in the same area of the target pest species). This selectivity may be based on the inherent chemical properties of the repellent compounds and their specific interactions with pest olfactory systems.

A concentration gradient may be employed, where a repellent compound is released at a level that may affect the behavior of a target pest species (e.g., by repelling it) while remaining below the detection threshold for a non-target species (e.g., humans or certain beneficial insects present in the same area of the target pest species). This gradient may be achieved through the controlled, passive diffusion of repellent compounds from the functional polymer.

To exploit passive environmental responsiveness, the functional polymer may be designed to respond to certain environmental factors that may correlate with pest activity, allowing for a degree of temporal control without active triggering mechanisms. For example, the polymer may release more compounds at higher temperatures, which may coincide with increased pest activity. As another example, the functional polymer may be engineered to release more compounds in response to higher humidity levels, which may correlate with certain pest activities. As a further example, if the polymer is light-sensitive, it may release compounds at varying rates depending on light exposure, potentially aligning with diurnal or nocturnal pest activity patterns.

One or more of the passive mechanisms described herein, or other passive mechanisms, used alone or in combination, may allow for a degree of selective targeting without the need for complex, active triggering systems. The release patterns may be based on the inherent properties of the functional polymer and its interactions with the environment.

Additionally or alternatively, one or more active mechanisms may be incorporated to achieve the selectivity and effectiveness of the pest repellent system. An active mechanism can provide a precise control over the release of repellent compounds, allowing for better targeting of pest species while minimizing impact on non-target organisms. Some examples of simple active mechanisms include a heating element, a diffusion device, a light-activated system, an electroactive polymer, or the like, or a combination thereof. A heating element, such as a heating wire or a heating patch, can be attached to or integrated with the pest repellent buffer. This controlled heat source can increase the release rate of volatile repellent compounds when activated. A diffusing device incorporating both the functional polymer and a triggering mechanism, e.g., a heater, a light source, can provide more controlled release of repellent compounds. The triggering mechanism can be activated to trigger or increase the diffusion rate of the repellents, allowing for a rapid response to pest presence or anticipated pest activity periods. A light source may include UV, visible, or infrared light, depending on the specific photochemical properties of a pest repellent agent, a functional polymer, a pest repellent buffer including a functional polymer, or a repellent system thereof. If the polymer substrate of the functional polymer may change one or more properties in response to electrical stimulation can be used to control the release of repellent compounds. A low-voltage electrical current can be applied to trigger the release of repellents, providing a layer of control over the temporal release pattern.

One or more of the active mechanisms exemplified above and other active mechanisms can be used individually or in combination with one or more of the passive mechanisms described earlier, or other passive mechanisms. The choice and implementation of these mechanisms can be tailored to the specific needs of the target pest species, the environmental conditions, and a desired level of control over the repellent release.

One or more of these mechanisms may allow the functional polymer or repellent buffer to effectively target pests while remaining imperceptible or non-offensive to humans and/or other non-target species (e.g., beneficial insects). This approach may maintain the “odor-free” characteristic from a human perspective while providing effective pest control. In some embodiments, the repellent effect may be tailored to specific pest species, allowing for targeted pest management without disrupting the broader ecosystem. This selective approach may contribute to the overall environmental friendliness and sustainability of the solution. This approach combines the inherent selectivity of the repellent compounds and polymer design with controllable release mechanisms, resulting in a more versatile and efficient pest management solution.

Silicone rubber, used as the polymer substrate in the functional polymer or repellent buffer is recyclable through, e.g., consumer and/or commercial recycle programs, including by manufacturer. When the concentration of the natural extract or other constituents dispersed in the polymer substrate decreases to below a threshold level, the polymer substrate may be recycled or repurposed into products of a high value, quality, or functionality. The functional polymer, as well as the repellent buffer, can be conveniently installed, including on an existing establishment, obviating the need to make a structural adjustment to the existing establishment to use the functional polymer or the repellent buffer.

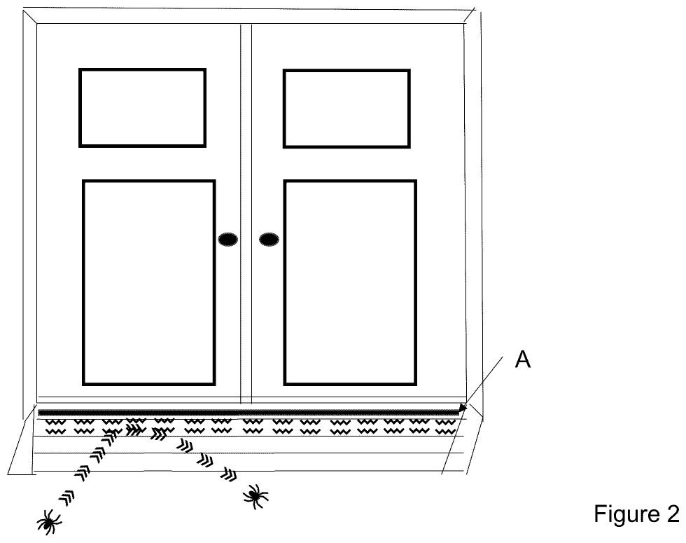

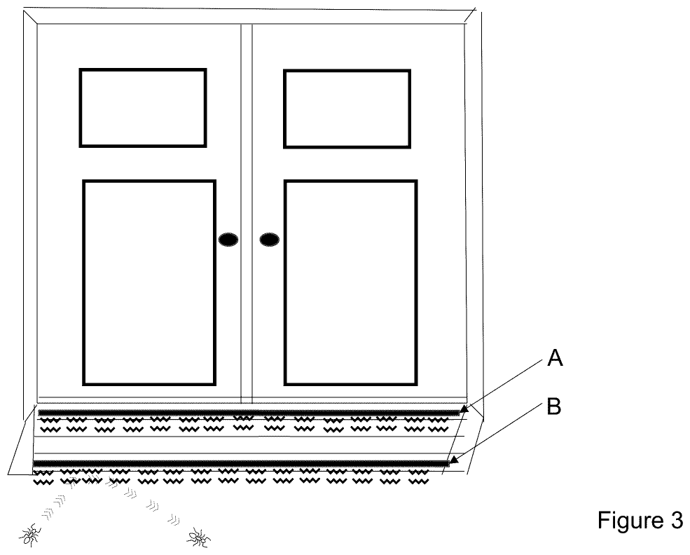

FIGS. 1-5 show exemplary use cases of one or more repellent buffers installed at or in a vicinity of a doorway according to some embodiments of the present document. The repellent buffer, also referred to as a bug buffer, can provide persistent repellent emission and insect barrier to a door entry. As illustrated in FIG. 1, a repellent buffer A is installed at or in a vicinity of a doorway such that ants are repelled. As illustrated in FIG. 2, a repellent buffer A is installed at or in a vicinity of a doorway such that spiders are repelled. As illustrated in FIG. 3, two repellent buffers A and B are installed at or in a vicinity of a doorway such that pests are repelled. The two repellent buffers A and B may include the same natural extract(s) or different natural extract(s).

As illustrated in FIGS. 4 and 5, three repellent buffers A, B, and C are installed at or in a vicinity of a doorway such that pests are repelled. At least two of the repellent buffers A, B, and C may include the same natural extract(s). Alternatively, all three repellent buffers A, B, and C may include different natural extract(s). The distance between the repellent buffers A and B is different from the distance between the repellent buffers B and C, as illustrated in FIG. 4. Alternatively, the repellent buffers A, B, and C may be equidistantly spaced, as illustrated in FIG. 5. The multiple repellent buffers may form a multilayer barrier for pest repulsion.

FIGS. 6A though 6E show exterior installations of repellent buffers according to some embodiments of the present document. FIGS. 6A and 6B show a repellent buffer (where the arrows 610A and 610B point) installed at a front door and at a back door, respectively. FIGS. 6C and 6D are close-up views of the repellent buffer as illustrated in FIG. 6A; the repellent buffer is annotated using a box 610D in FIG. 6D. FIG. 6E is a close-up view of the repellent buffer (where the arrow 610E points) installed at an entry threshold as illustrated in FIG. 6B.

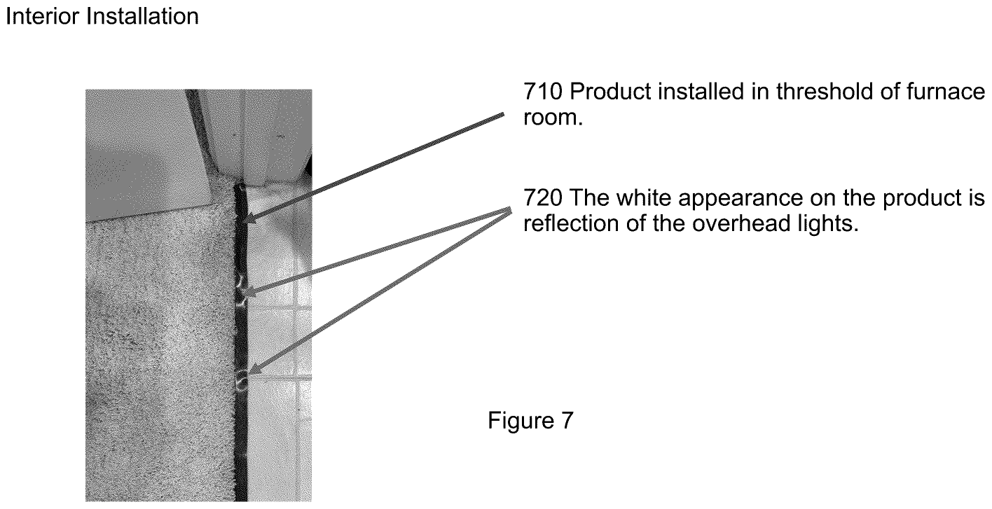

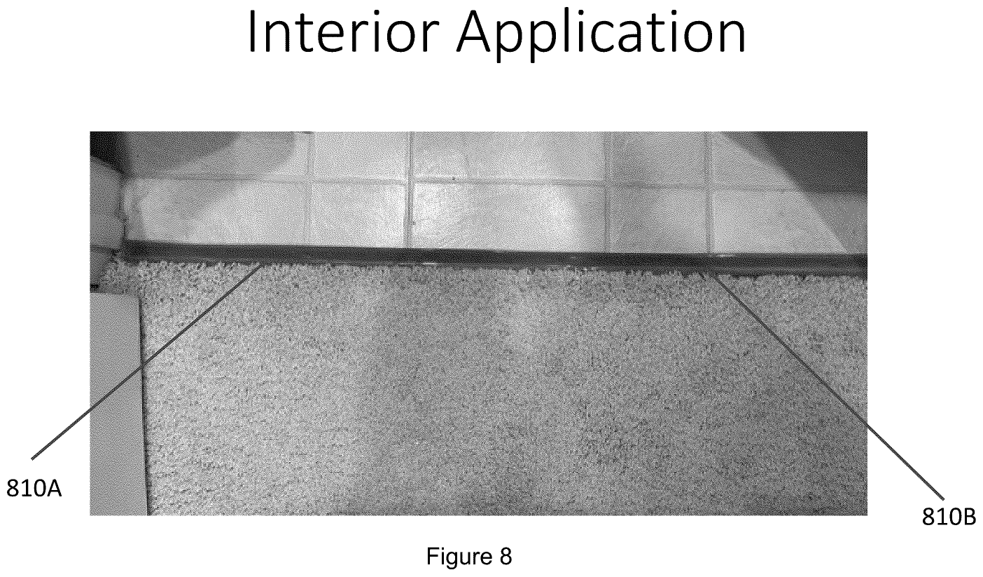

FIGS. 7 through 9B show interior installations of repellent buffers according to some embodiments of the present document. FIGS. 7 and 8 show a repellent buffer (denoted by arrows 710, 810A, and 810B) installed at a threshold of a furnace room. The white appearance denoted by 720 in FIG. 7 was a reflection of the overhead lights.

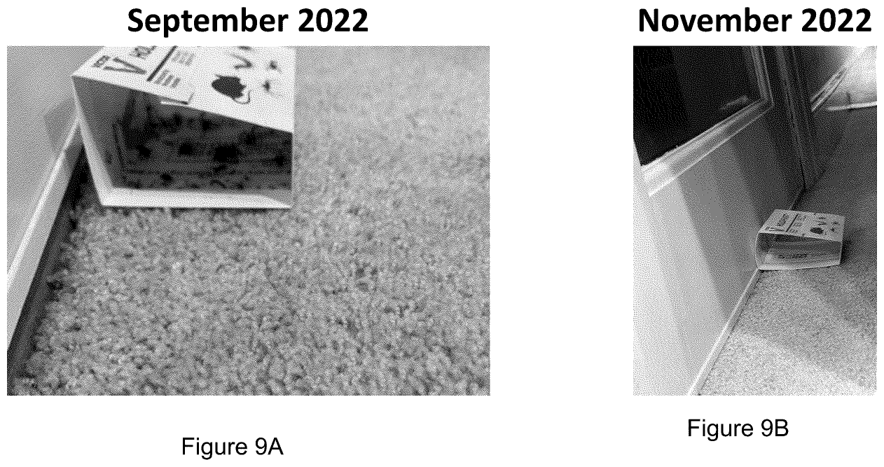

FIGS. 9A and 9B show a comparison of indoor glue trap insect catcher results when no repellent buffer was installed and when a repellent buffer was installed, respectively. The results in these figures illustrate the efficacy of the repellent buffers of embodiments of the present document.

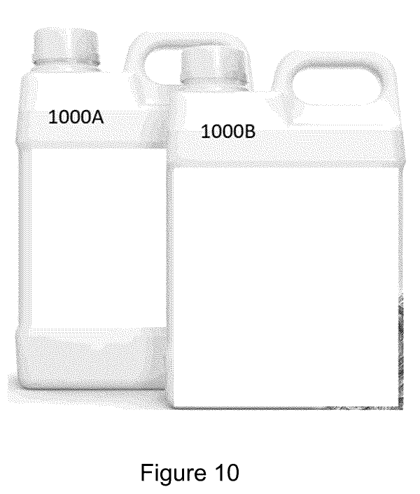

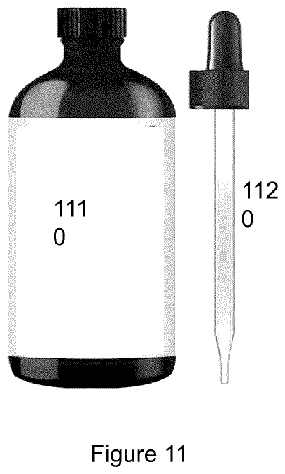

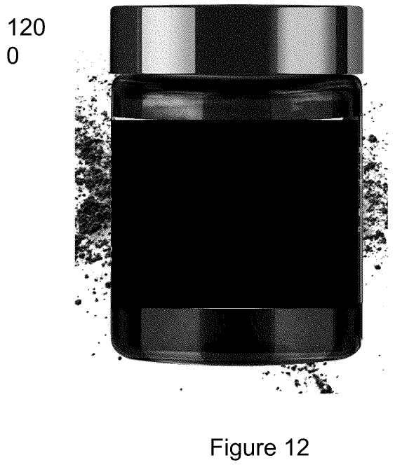

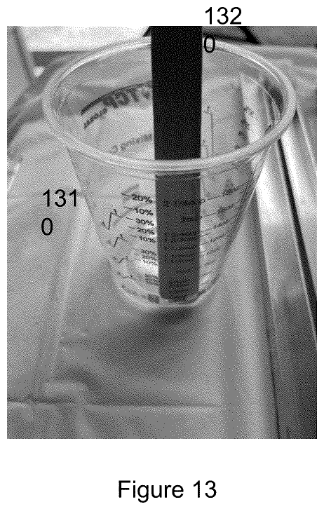

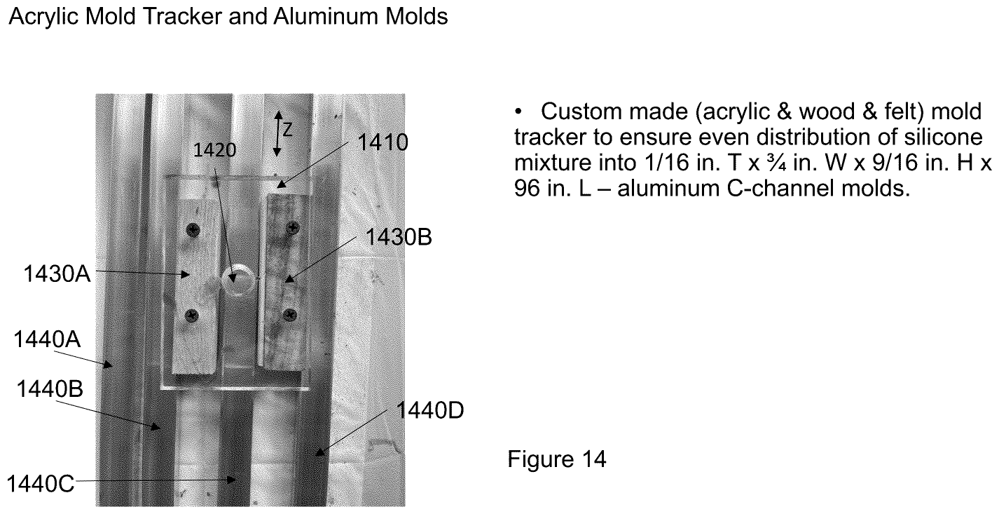

Some embodiments of the present document relate to a kit for making a repellent buffer. FIGS. 10-14 show components of such a kit. The kit may include a first component and a second component (as illustrated in FIG. 10), and a natural extract (as illustrated in FIG. 11). In some embodiments, the kit may include at least one of a colorant (as illustrated in FIG. 12), a mixing vessel (as illustrated in FIG. 13), a mixing tool (as illustrated in FIG. 13), a mold tracker (as illustrated in FIG. 14), and a mold (as illustrated in FIG. 14).

As illustrated in FIG. 10, the first component and a second component may be stored in separate containers. They may be stable under the room temperature. One or both of the containers may be airtight. One or both of the containers may be transparent or opaque. One or both of the containers may be resealable. The first component and a second component may be reactive upon mixing to produce a polymer substrate. In some embodiments, upon mixing, the first component and the second component, originally liquid, may solidify to produce the polymer substrate by UV radiation, thermal curing, or ambient air curing. The solidification may occur or accelerate in response to an external stimulus. Examples of such an external stimulus include the external stimulus comprises at least one of heat, light, a mechanical stress, or the like, or a combination thereof. In some embodiments, the first component 1000A and the second component 1000B may be constituents for making silicone rubber. Merely by way of example, the first component 1000A and the second component 1000B may be part A and part B of liquid silicone rubber (e.g., from LET'S RESIN). A polymer substrate including such silicone rubber may be non-toxic, odor-free, flexible, soft, and clear.

As illustrated in FIG. 11, the natural extract may be stored in a container 1110. The container may be airtight. The container may be transparent or opaque. The container may be resealable. The container 1110 may be equipped with a pipette 1120 (e.g., a glass pipette, a silicone pipette) for transferring the natural extract from the container 1110 for use. In some embodiments, the kit may include multiple natural extracts so that a use may select one or more natural extracts from the kit to make one or more repellent barrier. For example, the natural extract include peppermint essential oil-100% pure and natural, no filler, additives and undiluted (e.g., from HANDCRAFT BLENDS). Many other natural oil combinations may be used in product as well.

As illustrated in FIG. 12, the kit may include one or more colorants 1200. For example, the kit may include mica (e.g., LightStone Mica Powder, Black) as a colorant. The colorant may be a safe and non-toxic epoxy resin pigment. The colorant may include ingredients that are safe, vegan, cruelty free, and/or free from harmful chemicals and irritants.

FIG. 13 illustrates a mixing vessel 1310 and a mixing tool 1320 (e.g., a mixing stick). The mixing vessel 1310 may include a material that is inert to the components involved in making a repellent buffer according to some embodiments of the present document. For example, the mixing vessel 1310 may be made of plastic. The mixing tool 1320 may be made of wood. As illustrated, the mixing vessel 1310 may include measuring markings.

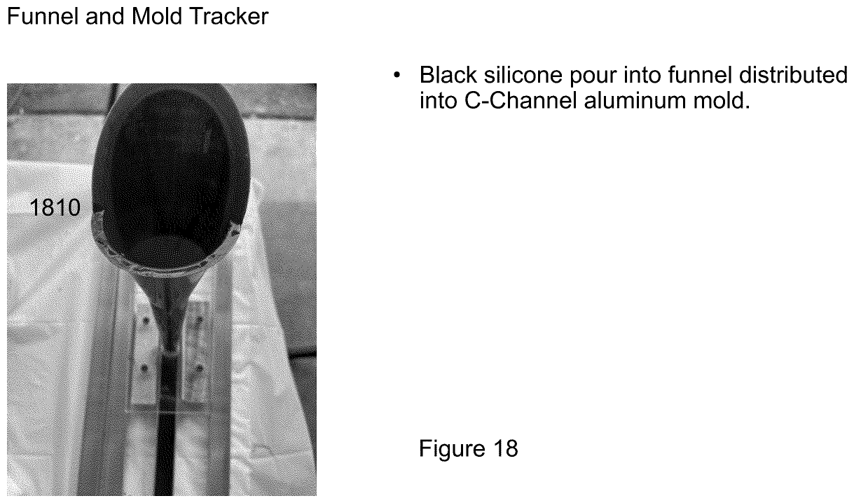

FIG. 14 illustrates a mold tracker and molds according to some embodiments of the present document. The mold tracker may include a cover 1410, and two mold guides 1430 (individually referred to as a first mold guide 1430A and a second mold guide 1430B) attached to the cover 1410. The cover 1410 has an opening 1420 configured to receive a funnel (e.g., funnel 1810 in FIG. 18) though which a liquid can flow into a mold 1440 (individually referred to as a first mold 1440A, a second mold 1440B, a third mold 1440C, and a fourth mold 1440D). The mold guides 1430 may be spaced apart by a distance substantially equal to a width of the mold 1440 such that the mold 1440 can fit between the mold guides 1430 and the cover 1410 (and a funnel 1810 received at the opening 1420 of the cover 1410) may slide along a length direction Z of the mold 1440. Such a movement of the funnel 1810 may facilitate a substantially even distribution of a liquid (e.g., liquid silicone) in the mold 1440. Merely by way of example, the cover 1410 may be made of acrylic; the mold guides 1430 may be made of wood. Merely by way of example, the mold 1440 may have a dimension of 1/16 in. T×¾ in. W× 9/16 in. H×96 in. L. The mold 1440 may be made of aluminum. The mold 1440 may have a cross-section perpendicular to the direction Z with a C shape, and the mold 1440 may be referred to a C-channel.

In some embodiments, the kit may include a set of instructions detailing a mixing ratio of the first component, the second component, and the natural extract. In some embodiments, the kit may include at least one of a UV stabilizer, a filler, a plasticizer, a flame retardant, or the like, or a combination thereof. In some embodiments, the kit may include a glue tape.

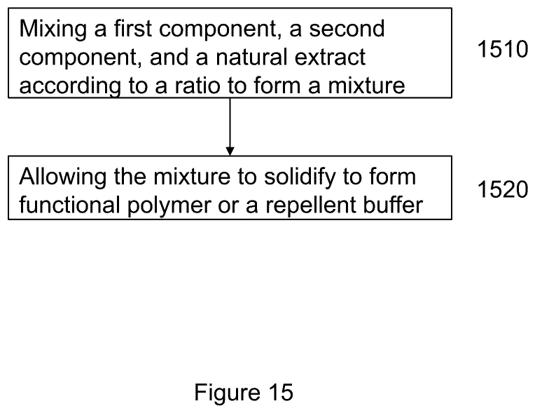

FIG. 15 illustrates a process for making a repellent buffer according to some embodiments of the present document. At 1510, a first component, a second component, and a natural extract is mixed. For example, the first component, the second component, and the natural extract may be added to a mixing vessel 1310 and mixed using the mixing tool 1320. Additionally or alternatively, the mixing may be achieved or enhanced using a device, e.g., an automated mixer, a shaker, or the like, or a combination thereof. The mixing may be performed at room temperature, or at a temperature different from the room temperature (e.g., higher or lower than the room temperature achieved using a water bath).

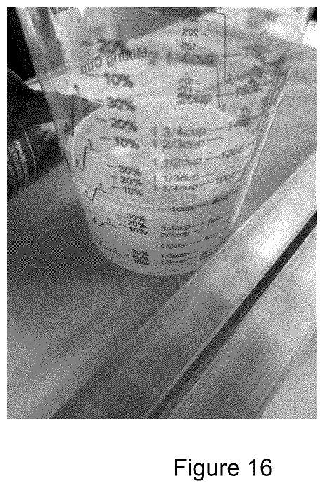

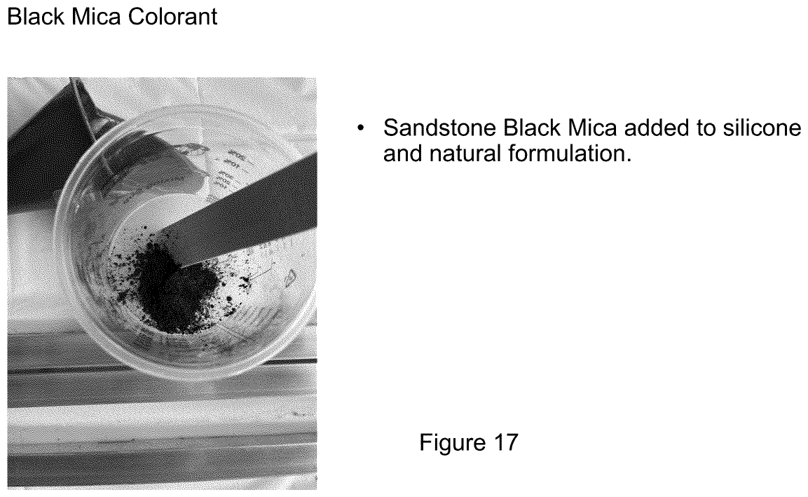

Merely by way of example, the first component and the second component may be silicone rubber components that are reactive upon mixing to form silicone rubber. The first component and the second component may be mixed at the ratio of 1:1 by weight. The natural extract in the mixture may disperse in the silicone rubber. See, for example, FIG. 16. One or more natural extracts may be used to form the mixture. The amount of a natural extract to the amount the polymer substrate may be in the order of 1/1000, or 1/100, or 1/10. The amount of a first natural extract to the amount a second natural extract may be in the order of 1/100, or 1/10, or 1. Example compositions of mixtures for producing repellent buffers are provided in Appendix A. In some embodiments, a colorant (e.g., mica) may be added to the mixing vessel to form the mixture. See, e.g., FIG. 17.

In some embodiments, multiple natural extracts may be added to form the mixture. E

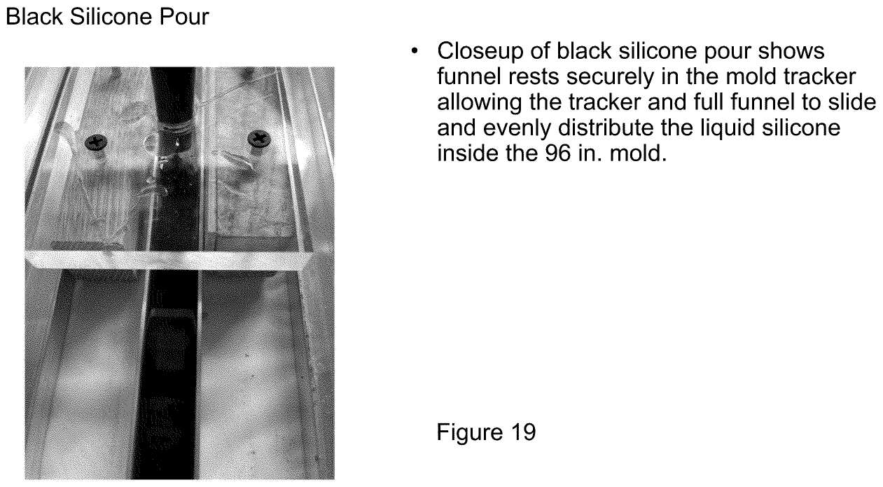

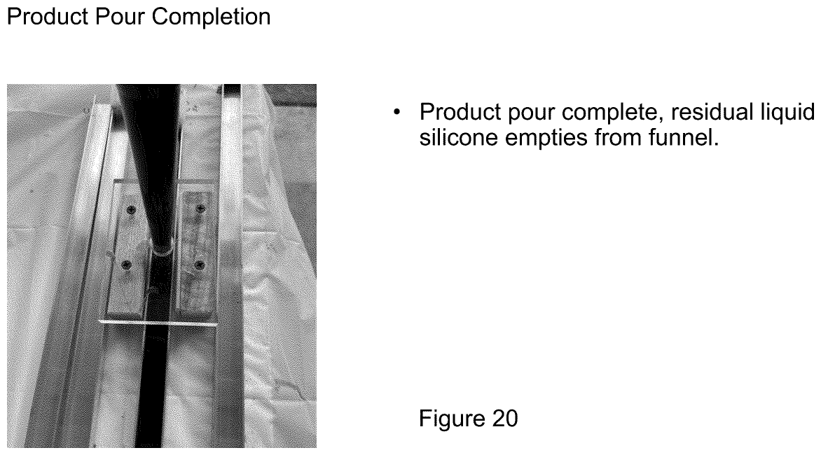

At 1520, the mixture may be allowed to solidify to form functional polymer or a repellent buffer. The mixture may be poured to a mold where it solidifies. For example, the mixture may be poured to a mold via a funnel 1810 as illustrated in FIG. 18. The funnel 1810 may be fluidly coupled to the mold via a mold tracker (e.g., the mold tracker as illustrated in FIG. 14). As illustrated in FIG. 19, by sliding the mold tracker along the length direction of the mold, the mixture may be distributed to the mold substantially evenly via the funnel 1810 that slides along the length direction of the mold with the mold tracker. As illustrated in FIG. 20, when the mold is filled with the mixture (or when the mixture in the funnel 1810 is emptied), the funnel 1810 may be removed from the mold (or the residual mixture may be emptied if applicable).

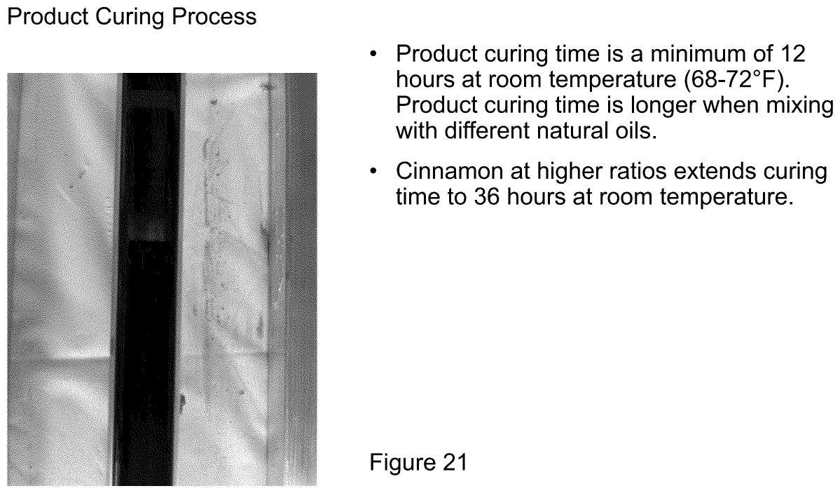

Then the mixture may be allowed to solidify in the mold. The solidification time (also referred to as cure time) may be in the order of 1 hour to 10 hours (e.g., 12 hours) at room temperature (68-72° F.) for silicone rubber. The cure time may depend on the composition of the mixture. The cure time may be longer when the mixture includes different natural oils. Merely by way of example, for a mixture including cinnamon oil at higher ratios, the cure time may extend to 36 hours at room temperature. See, e.g., FIG. 21.

Merely by way of example, a natural oil bug and pest repellant impregnated silicone rubber formulation is as follows:
1. 2-part silicone rubber mix Part A & Part B; combine Part A & Part B, mix ratio is 1:1 by weight;
2. slowly stir silicone rubber mix for 3 minutes;
3. after three minutes add essential oils (also referred to as natural extracts) and stir for two minutes;
4. after two minutes add mica for coloring and stir for two minutes;
5. position acrylic mold tracker over mold and insert funnel;
6. pour silicone rubber into 1×½×95 inch aluminum molds;
7. cure for 8-15 hours depending on temperature;
8. layer double sided tape during cure process or post cure with silicone glue;
9. extract from mold and coil and seal in plastic bag;
10. package with double side adhesive tape to secure in location.

The exemplary process provides a yield of the bug barrier (also referred to as repellent buffer) 65″×¾″×½″, and the corresponding volume is 24.38 cubic inches.

A repellent buffer based on the disclosed technology may include one or more adhesive surfaces for engaging the repellent buffer to one or more surfaces at a location of deployment of the repellent buffer. For example, an adhesive layer with an adhesive material may be formed on one side surface of the polymer substrate of such a repellent buffer and a flexible release liner may be formed to cover the adhesive layer in a final repellent buffer product for easy installation. A user can peel off the flexible release liner to expose the side surface with the adhesive layer and adhere the repellent buffer to a surface to complete the installation.

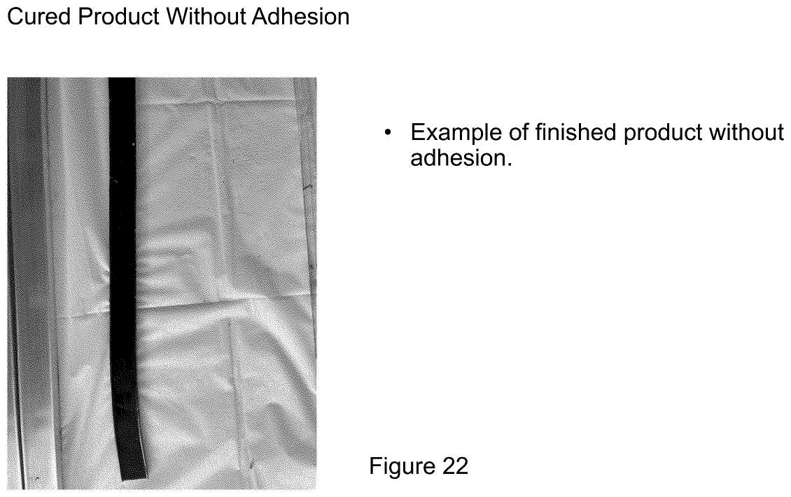

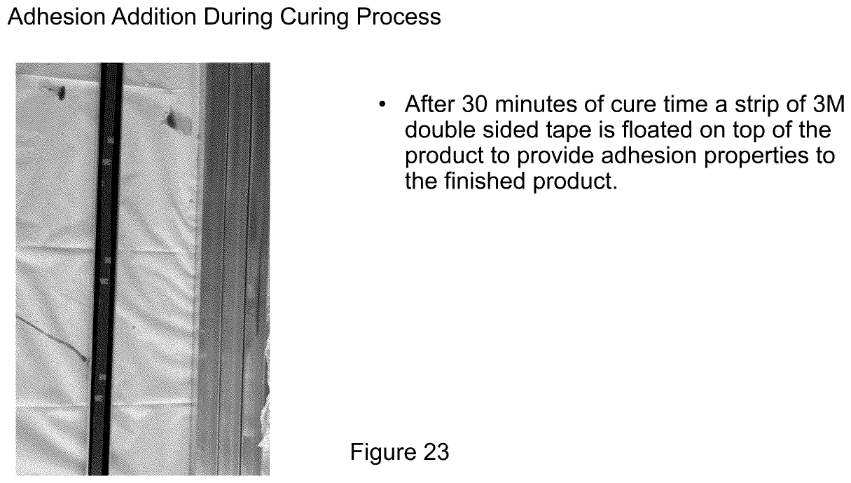

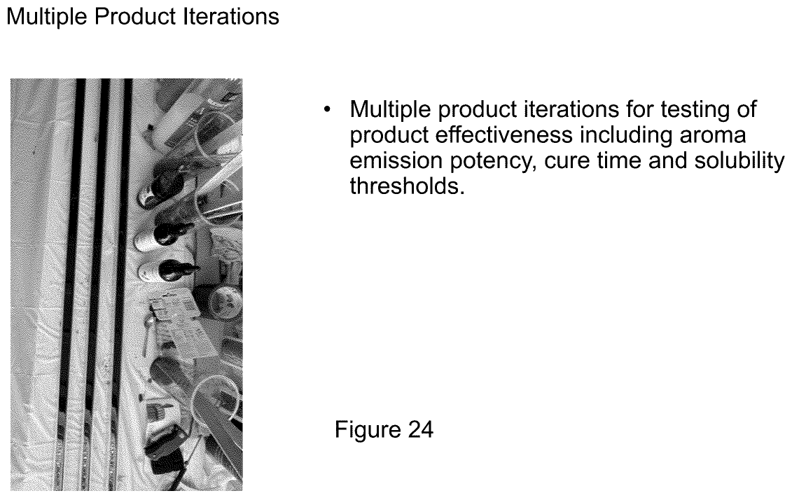

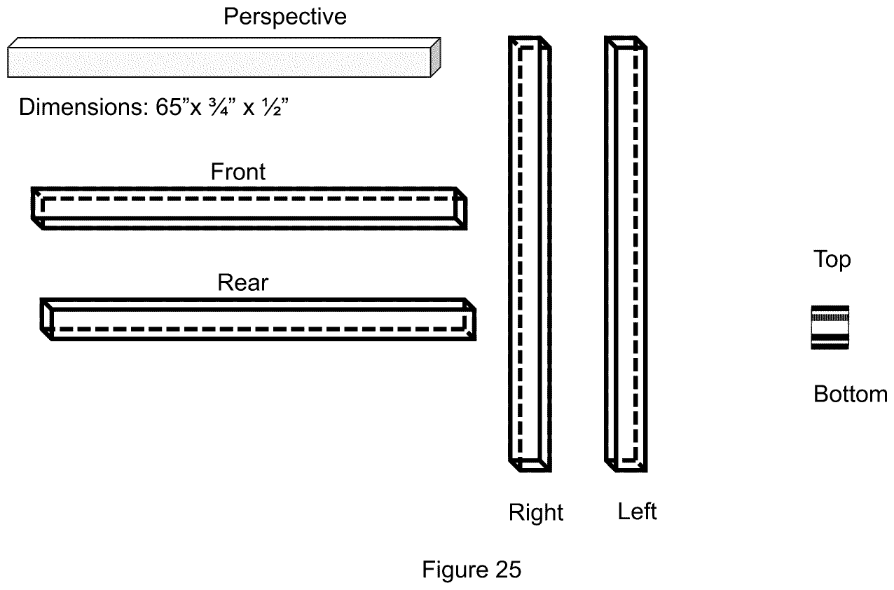

Another way for providing one or more adhesive surfaces is to apply an adhesive tape to the repellent buffer. FIG. 22 illustrates an example of a strip of repellent buffer produced. As illustrated in FIG. 23, a double-sided glue tape with release liners may be applied to a surface of the strip so that the strip may be used conveniently by attaching to a surface (e.g., at or in a vicinity of a doorway). FIG. 24 illustrates various examples of repellent buffers produced with different aroma emission potencies, cure times, and/or solubility thresholds. FIG. 25 shows various views of an example of a repellent buffer without an adhesive strip.

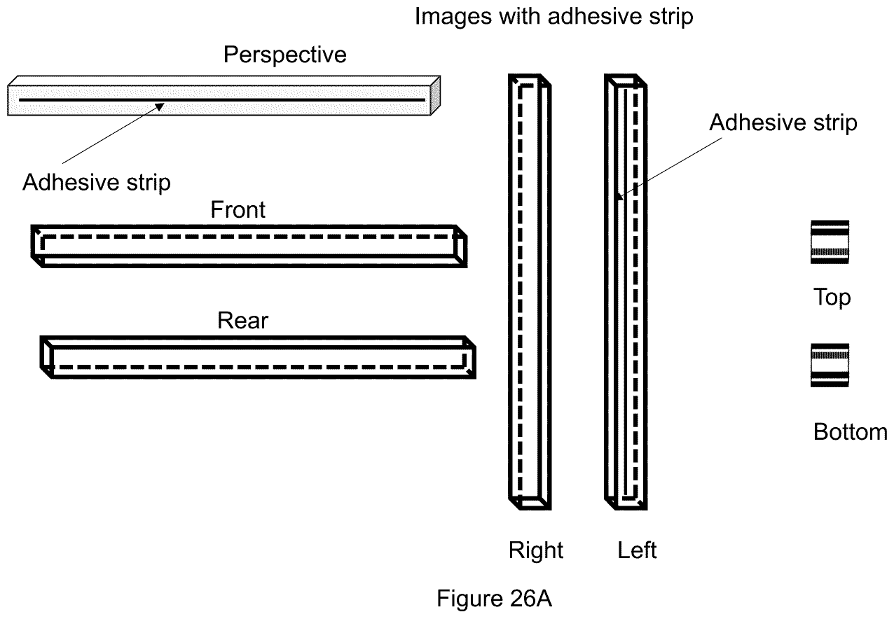

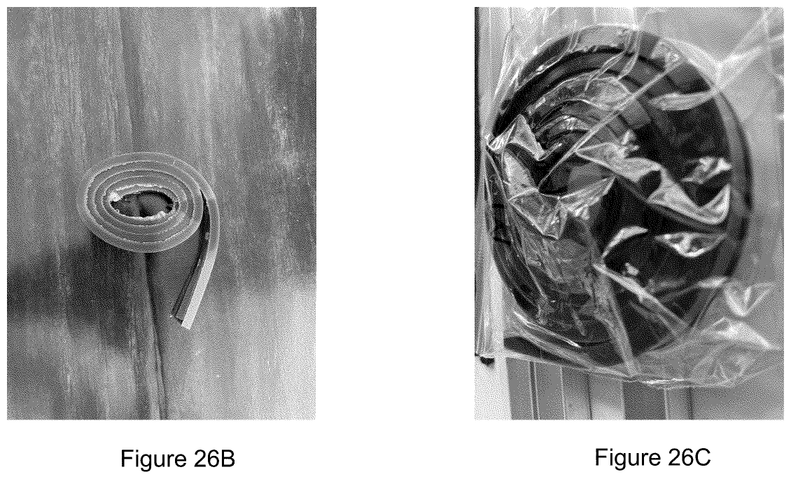

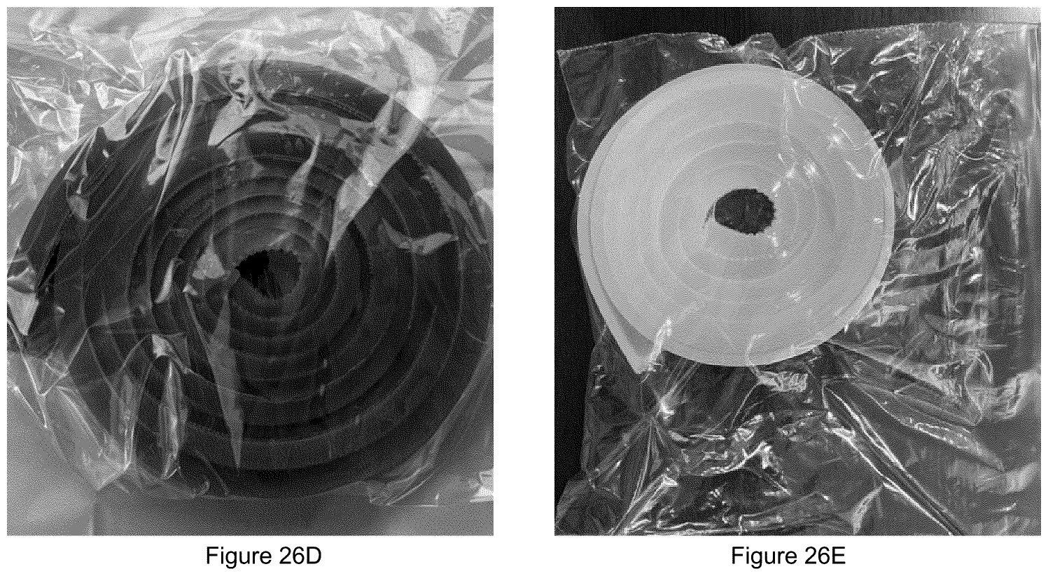

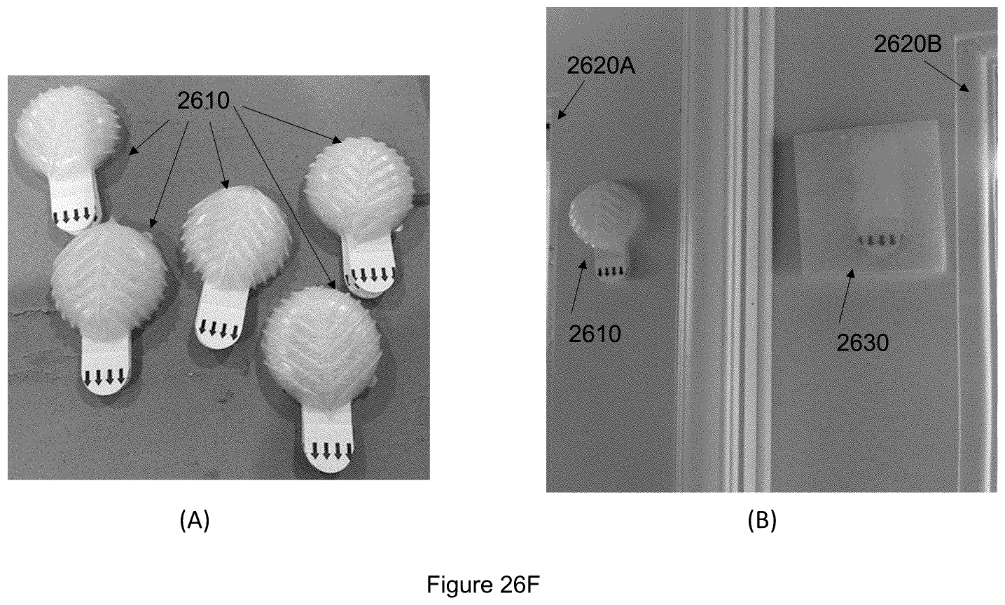

FIG. 26A shows various views of an example of a repellent buffer without and with an adhesive strip (e.g., a double-sided glue tape), respectively. FIG. 26B shows an example of a repellent buffer with adhesion coiled for packaging. FIGS. 26C through 26E show examples of repellent buffers with adhesion coiled in sealed packaging. As illustrated in FIGS. 26A through 26D, repellent buffers of different colors (e.g., grey, black, clear, or another color) may be produced to achieve suitable appearance for various applications.

To create one or more adhesive surfaces on a repellent buffer, another exemplary approach is the use of nano tape, which features a microstructure of suction cups. This may provide strong adhesion while leaving no residue upon removal or replacement. Alternative attachment methods or components may include magnets, hook-and-loop fasteners (commonly known by the brand name Velcro®), etc.

FIG. 26F illustrate an example mold including a pest repellent agent configured repellent buffer according to some embodiments of the present document. Panel (A) of FIG. 26F illustrates example molds 2610 that include a pest repellent agent configured to repel mosquitos in panel A. Panel (B) illustrates an example mold 2610 as illustrated in (A) affixed to a wall close to external door frames 2620 (individually identified as 2620A and 2620B) to repel mosquitos. Panel (B) also show the functional polymer configured as a patch or board 2630 including the pest repellent agent affixed to the wall close to external door frames 2620.

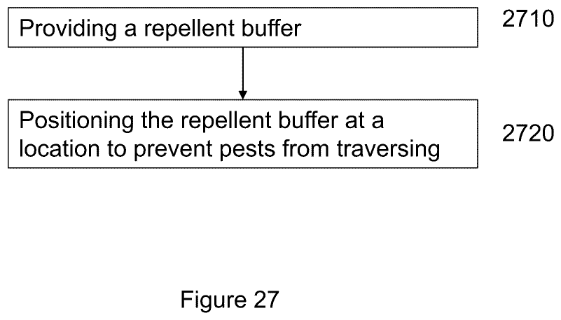

FIG. 27 illustrates a process for using a repellent buffer according to some embodiments of the present document. At 2710, a repellent buffer is provided. The repellent buffer may be produced as described elsewhere of the present document. At 2720, the repellent buffer is positioned at a location to prevent pests from traversing the location. The location may be indoor or outdoor. The location may at an entry threshold from outside to inside (e.g., a front door of a house or building), or from one part of a building to another part (e.g., from living room to kitchen, from living room to basement, from kitchen to pantry room, etc.). By positioning the repellent buffer at such a location, the natural extract(s) dispersed in the repellent buffer may be released over time to repel pests away from the repellent buffer and therefore prevent such pests to enter the portion of the building protected by the repellent buffer. In some embodiments, the repellent buffer may be used within a portion of furniture or another structure (e.g., pantry door, window, etc.).

### EXAMPLES

The following examples are illustrative of several embodiments of the present technology.

Example 1. A pest repellant device, comprising:
a polymer substrate formed of a polymer material, and
a pest repellent agent dispersed within the polymer substrate to generate a pest repellent odor that repels pests.

Example 2. The pest repellant device of any one or more examples disclosed herein, wherein the pest repellent agent comprises a natural extract.

Example 3. The pest repellant device of any one or more examples disclosed herein, wherein the pest repellent agent comprises at least one of peppermint oil, lemongrass oil, lavender oil, rosemary oil, basil, lemon, eucalyptus oil, lemon eucalyptus, clove oil, lemon oil, patchouli, sage, spearmint, vetiver, tea tree oil, cedarwood oil, citronella oil, orange oil, cinnamon oil, thyme oil, garlic extract, or neem oil, or a combination thereof.

Example 4. The pest repellant device of any one or more examples disclosed herein, wherein the polymer substrate is configured to allow the pest repellent agent to release the pest repellent odor at a constant release rate.

Example 5. The pest repellant device of any one or more examples disclosed herein, wherein the polymer substrate is configured to allow the pest repellent agent to be released therefrom at a release rate that relates to an external stimulus.

Example 6. The pest repellant device of any one or more examples disclosed herein, wherein the external stimulus comprises at least one of heat, light, moisture, or a mechanical stress.

Example 7. The pest repellant device of any one or more examples disclosed herein, wherein the polymer substrate comprises a silicone material. The silicone material may be flexible and/or deformable.

Example 8. The pest repellant device of any one or more examples disclosed herein, wherein the polymer substrate has a shape of an elongated strip.

Example 9. The pest repellant device of any one or more examples disclosed herein, wherein the polymer substrate has a shape of a board.

Example 10. The pest repellant device of claim 1, wherein the polymer substrate includes a substrate surface with an adhesive for installing the pest repellant device.

Example 11. A pest repellant kit for producing a pest repellant device, comprising:
a first component material,
a second component material, wherein the first component and the second component are reactive upon mixing with each other to produce a flexible and deformable polymer substrate,
a third component material that exhibits a pest repellent odor that repels one or more pests and can be mixed with the first and second component materials to enable the flexible and deformable polymer substrate to release the pest repellent odor, and
a set of instructions to instruct a user to mix the first, second and third component materials at one or more mixing ratios to form the flexible and deformable polymer substrate.

Example 12. The pest repellant kit of any one or more examples disclosed herein, wherein the set of instructions includes information for curing the first, second and third component materials by UV radiation, thermal curing, or ambient air to form the flexible and deformable polymer substrate.

Example 13. The pest repellant kit of any one or more examples disclosed herein, further comprising a mixing vessel for holding and mixing the first, second and third component materials.

Example 14. The pest repellant kit of any one or more examples disclosed herein, wherein the mixing vessel includes measurement markings for mixing the first, second and third component materials.

Example 15. The pest repellant kit of any one or more examples disclosed herein, further comprising
a mold configured to hold a mixture of the first, second and third component materials to solidify into a desired shape provided by the mold,
a funnel configured to guide the mixture to fill in the mold, and
a mold tracker configured to guide the funnel to slide along the mold along a length direction of the mold to spread the mixture in the mold.

Example 16. The pest repellant kit of any one or more examples disclosed herein, further comprising a fourth component material that is to be mixed with the first, second and third component materials as part of the flexible and deformable polymer substrate and that includes at least one of a UV stabilizer, a colorant, a filler, a plasticizer, or a flame retardant.

Example 17. The pest repellant kit of any one or more examples disclosed herein, wherein the first, second and third component materials are packaged in separate containers, each container being sealable and resealable.

Example 18. The pest repellant kit of any one or more examples disclosed herein, further comprising a glue tape.

Example 19. A method of making a functional polymer as a pest repellent buffer, comprising:
mixing a first polymer pre-cursor material, a second polymer pre-cursor material, and a material that releases a pest repellent odor that repels one or more pests according to a ratio to form a mixture; and
curing the mixture to solidify the mixture to form the functional polymer, wherein:
   the first and second polymer pre-cursor materials are reactive to produce a polymer material upon mixing in which the material that releases the pest repellent odor is dispersed.

Example 20. The method of any one or more examples disclosed herein, wherein curing the mixture comprises applying an external stimulus to the mixture.

Example 21. The method of any one or more examples disclosed herein, wherein the external stimulus comprises at least one of heat, light, or a mechanical stress.

Example 22. The method of any one or more examples disclosed herein, wherein the curing includes applying UV radiation, heat, or supplying air flow to the mixture.

Example 23. The method of any one or more examples disclosed herein, further comprising applying the mixture to a mold to shape the mixture.

Example 24. The method of any one or more examples disclosed herein, further comprising applying an adhesive layer to a surface of the repellent buffer.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described and other implementations, enhancements and variations can be made based on what is described and illustrated in this patent document

### Example Formulations I(A)

| | Peppermint Oil | | | | |
|---|---|---|---|---|---|
| | ml | ml | ml | ml | g |
| Peppermint Oil | 1 | 2 | 4 | 8 | |
| Silicone | 237 | 237 | 237 | 237 | |
| Rubber | | | | | |
| Mica | | | | | 3 |

Add in the natural oils and mica during the mixing of reactive components of the silicone rubber.

### Example Formulations I(B)

| | Peppermint Oil | | | | |
|---|---|---|---|---|---|
| | ml | ml | ml | ml | g |
| Peppermint Oil | 1 | 2 | 4 | 8 | |
| Silicone Rubber | 170 | 170 | 170 | 170 | |
| Mica | | | | | 3 |

Add in the natural oils and mica during the mixing of reactive components of the silicone rubber.

### Example Formulations II(A)

| Peppermint Dominant | ml | ml | ml | ml | g |
|---|---|---|---|---|---|
| Peppermint Oil | 1 | 2 | 4 | 8 | |
| Eucalyptus Oil | 0.5 | 1 | 2 | 4 | |
| Silicone Rubber | 237 | 237 | 237 | 237 | |
| Mica | | | | | 3 |

Add in the natural oils and mica during the mixing of reactive components of the silicone rubber.

### Example Formulations II(B)

| Peppermint Dominant | ml | ml | ml | ml | g |
|---|---|---|---|---|---|
| Peppermint Oil | 1 | 2 | 4 | 8 | |
| Eucalyptus Oil | 0.5 | 1 | 2 | 4 | |
| Silicone Rubber | 170 | 170 | 170 | 170 | |
| Mica | | | | | 3 |

Add in the natural oils and mica during the mixing of reactive components of the silicone rubber.

### Example Formulations III(A)

| Cinnamon Oil | ml | ml | ml | ml | g |
|---|---|---|---|---|---|
| Cinnamon Oil | 1 | 2 | 4 | 8 | |
| Silicone Rubber | 237 | 237 | 237 | 237 | |
| Mica | | | | | 3 |

Add in the natural oils and mica during the mixing of reactive components of the silicone rubber.

### Example Formulations III(B)

| Cinnamon Oil | ml | ml | ml | ml | g |
|---|---|---|---|---|---|
| Cinnamon Oil | 1 | 2 | 3 | 4 | |
| Silicone Rubber | 170 | 170 | 170 | 170 | |
| Mica - Black | | | | | 3 |

Add in the natural oils and mica during the mixing of reactive components of the silicone rubber.

### Example Formulations IV(A)

| Cinnamon Dominant | ml | ml | ml | ml | g |
|---|---|---|---|---|---|
| Cinnamon Oil | 1 | 2 | 4 | 8 | |
| Peppermint Oil | 0.5 | 1 | 2 | 4 | |
| Eucalyptus Oil | 0.5 | 1 | 2 | 4 | |
| Silicone Rubber | 237 | 237 | | | 3 |

Add in the natural oils and mica during the mixing of reactive components of the silicone rubber.

### Example Formulations IV(B)

| Cinnamon Dominant | ml | ml | ml | ml | g |
|---|---|---|---|---|---|
| Cinnamon Oil | 1 | 2 | 4 | 8 | |
| Peppermint Oil | 0.5 | 1 | 2 | 4 | |
| Eucalyptus Oil | 0.5 | 1 | 2 | 4 | |
| Silicone Rubber | 170 | 170 | 170 | 170 | |
| Mica - Black | | | | | 3 |

Add in the natural oils and mica during the mixing of reactive components of the silicone rubber.

### Example Formulations V(A)

| Lemon Eucalyptus C | ml | ml | ml | ml | g |
|---|---|---|---|---|---|
| Lemon Eucalyptus Oil | 1 | 2 | 4 | 8 | |
| Peppermint Oil | 0.05 | 1 | 2 | 8 | |
| Silicone Rubber | 237 | 237 | 237 | 237 | |
| Mica | | | | | 3 |

Add in the natural oils and mica during the mixing of reactive components of the silicone rubber.

### Example Formulations V(B)

| Lemon Eucalyptus | ml | ml | ml | g |
|---|---|---|---|---|
| Lemon Eucalyptus Oil | 1 | 2 | 4 | |
| Peppermint Oil | 0.05 | 1 | 2 | |
| Silicone Rubber | 170 | 170 | 170 | |
| Mica - Black | | | | 3 |

Add in the natural oils and mica during the mixing of reactive components of the silicone rubber.

### Example Formulations VI(A)

| Lavender Oil Dominant | ml | ml | ml | ml | g |
|---|---|---|---|---|---|
| Lavender Oil | 1 | 2 | 4 | 8 | |
| Peppermint Oil | 0.05 | 1 | 2 | 8 | |
| Silicone Rubber | 237 | 237 | 237 | 237 | |
| Mica | | | | | 3 |

Add in the natural oils and mica during the mixing of reactive components of the silicone rubber.

### Example Formulations VI(B)

| Lavender Oil Dominant | ml | ml | ml | ml | |
|---|---|---|---|---|---|
| Lavender Oil | 1 | 2 | 4 | 8 | |
| Peppermint Oil | 0.05 | 1 | 2 | 8 | |
| Silicone Rubber | 170 | 170 | 170 | 170 | |
| Mica - Black | | | | | 3 |

Add in the natural oils and mica during the mixing of reactive components of the silicone rubber.

### Example Formulations VII(A)

| Multilayer | ml | ml | ml | ml | g |
|---|---|---|---|---|---|
| Peppermint Oil | 1 | 2 | 4 | 8 | |
| Cinnamon | 1 | 2 | 4 | 8 | |
| Lemon Eucalyptus | 1 | 2 | 4 | 8 | |
| Lavender Oil | 1 | 2 | 4 | 8 | |
| Silicone Rubber | 237 | 237 | 237 | 237 | |
| Mica = 3 g per layer | | | | | 3 |

Add in the natural oils and mica during the mixing of reactive components of the silicone rubber.

### Example Formulations VII(B)

| Multilayer | ml | ml | ml | ml | g |
|---|---|---|---|---|---|
| Peppermint Oil | 1 | 2 | 4 | 8 | |
| Cinnamon | 1 | 2 | 4 | 8 | |
| Lemon Eucalyptus | 1 | 2 | 4 | 8 | |
| Lavender Oil | 1 | 2 | 4 | 8 | |
| Silicone Rubber - per layer | 114 | 114 | 114 | 114 | |
| Mica - Black = 2 g per layer | | | | | 2 |

Add in the natural oils and mica during the mixing of reactive components of the silicone rubber.

### Example Formulations VIII

| Lemon Oil | ml | ml | ml | ml | g |
|---|---|---|---|---|---|
| Lemon Oil | 1 | 2 | 4 | 8 | |
| Silicone Rubber | 170 | 170 | 170 | 170 | |
| Mica - Black | | | | | 3 |

Add in the natural oils and mica during the mixing of reactive components of the silicone rubber.

### Example Formulations IX

| Orange Oil | ml | ml | ml | ml | g |
|---|---|---|---|---|---|
| Orange Oil | 1 | 2 | 4 | 8 | |
| Silicone Rubber | 170 | 170 | 170 | 170 | |
| Mica - Black | | | | | 3 |

Add in the natural oils and mica during the mixing of reactive components of the silicone rubber.

### Example Formulations X

| Orange/Peppermint | ml | g |
|---|---|---|
| Orange Oil | 1.25 | |
| Peppermint Oil | 1.25 | |
| Silicone Rubber | 170 | |
| Mica - Black | | 3 |

Add in the natural oils and mica during the mixing of reactive components of the silicone rubber.

### Example Formulations XI

| Orange/Cinnamon | ml | g |
|---|---|---|
| Orange Oil | 1.25 | |
| Cinnamon Oil | 1.25 | |
| Silicone Rubber | 170 | |
| Mica - Black | | 3 |

Add in the natural oils and mica during the mixing of reactive components of the silicone rubber.

### Example Formulations XII

| Orange/Peppermint | ml | g |
|---|---|---|
| Orange | 1.25 | |
| Cinnamon | 1.25 | |
| Peppermint | 1.25 | |
| Silicone Rubber | 170 | |
| Mica - Black | | 3 |

Add in the natural oils and mica during the mixing of reactive components of the silicone rubber.

### Example Formulations XIII

| Tea Tree | ml | ml | ml | ml | g |
|---|---|---|---|---|---|
| Tea Tree | 1 | 2 | 4 | 8 | |
| Silicone Rubber | 170 | 170 | 170 | 170 | |
| Mica - Black | | | | | 3 |

Add in the natural oils and mica during the mixing of reactive components of the silicone rubber.

### Example Formulations XIV

| Citronella | ml | ml | ml | ml | g |
|---|---|---|---|---|---|
| Citronella | 1 | 2 | 4 | 8 | |
| Silicone Rubber | 170 | 170 | 170 | 170 | |
| Mica - Black | | | | | 3 |

Add in the natural oils and mica during the mixing of reactive components of the silicone rubber.

### Example Formulations XV

| White Vinegar | ml | ml | ml | ml | g |
|---|---|---|---|---|---|
| White Vinegar | 1 | 2 | 4 | 8 | |
| Silicone Rubber | 170 | 170 | 170 | 170 | |
| Mica - Black | | | | | 3 |

Add in the natural oils and mica during the mixing of reactive components of the silicone rubber.

### List of Example Natural Oils Applicable in Embodiments of the Present Document

Peppermint Oil—repels (ants, spiders, silverfish, stink bugs, gnats, bedbugs, centipedes, crickets, earwigs, moths, snails aphids, beetles, caterpillars, fleas, lice, moths, slugs, snails, mice, rats, squirrels, skunks, voles, groundhogs, moles, raccoons, woodpeckers)
Lemongrass Oil
Lavender Oil
Rosemary
Basil
Lemon
Eucalyptus Oil
Lemon Eucalyptus
Clove Oil
Lemon
Patchouli
Sage
Spearmint
Vetiver
Tea Tree Oil
Cedarwood Oil
Citronella Oil
Orange Oil
Cinnamon Oil (ants, roaches, mosquitoes, spiders, fruit flies, wasps, weevils, silverfish, bedbugs, houseflies, onion thrips, peach-potato aphids, scorpions, slugs, moths)
Cinnamon Oil (ants, roaches, mosquitoes, spiders, fruit flies, wasps, weevils, silverfish, bedbugs, houseflies, onion thrips, peach-potato aphids, scorpions, slugs, moths) Neem

What is claimed is:

1. A pest repellant device, comprising:
a polymer substrate formed of a polymer material, and
a pest repellent agent dispersed within the polymer substrate to generate a pest repellent odor that repels pests.

2. The pest repellant device of claim 1, wherein the pest repellent agent comprises a natural extract.

3. The pest repellant device of claim 1, wherein the pest repellent agent comprises at least one of peppermint oil, lemongrass oil, lavender oil, rosemary oil, basil, lemon, eucalyptus oil, lemon eucalyptus, clove oil, lemon oil, patchouli, sage, spearmint, vetiver, tea tree oil, cedarwood oil, citronella oil, orange oil, cinnamon oil, thyme oil, garlic extract, or neem oil, or a combination thereof.

4. The pest repellant device of claim 1, wherein the polymer substrate is configured to allow the pest repellent agent to release the pest repellent odor at a constant release rate.

5. The pest repellant device of claim 1, wherein the polymer substrate is configured to allow the pest repellent agent to be released therefrom at a release rate that relates to an external stimulus.

6. The pest repellant device of claim 5, wherein the external stimulus comprises at least one of heat, light, moisture, or a mechanical stress.

7. The pest repellant device of claim 1, wherein the polymer substrate comprises a silicone material.

8. The pest repellant device of claim 1, wherein the polymer substrate has a shape of an elongated strip, or a board.

9. The pest repellant device of claim 1, wherein the polymer substrate includes a substrate surface with an adhesive for installing the pest repellant device.

10. A pest repellant kit for producing a pest repellant device, comprising:
a first component material,
a second component material, wherein the first component and the second component are reactive upon mixing with each other to produce a flexible and deformable polymer substrate,
a third component material that exhibits a pest repellent odor that repels one or more pests and can be mixed with the first and second component materials to enable the flexible and deformable polymer substrate to release the pest repellent odor, and
a set of instructions to instruct a user to mix the first, second and third component materials at one or more mixing ratios to form the flexible and deformable polymer substrate.

11. The pest repellant kit of claim 10, wherein the set of instructions includes information for curing the first, second and third component materials by UV radiation, thermal curing, or ambient air to form the flexible and deformable polymer substrate.

12. The pest repellant kit of claim 10, further comprising at least one of:
a mixing vessel for holding and mixing the first, second and third component materials,
a mold configured to hold a mixture of the first, second and third component materials to solidify into a desired shape provided by the mold,
a funnel configured to guide the mixture to fill in the mold, or
a mold tracker configured to guide the funnel to slide along the mold along a length direction of the mold to spread the mixture in the mold.

13. The pest repellant kit of claim 10, further comprising a fourth component material that is to be mixed with the first, second and third component materials as part of the flexible and deformable polymer substrate and that includes at least one of a UV stabilizer, a colorant, a filler, a plasticizer, or a flame retardant.

14. The pest repellant kit of claim 10, further comprising a glue tape.

15. A method of making a functional polymer as a pest repellent buffer, comprising:
mixing a first polymer pre-cursor material, a second polymer pre-cursor material, and a material that releases a pest repellent odor that repels one or more pests according to a ratio to form a mixture; and
curing the mixture to solidify the mixture to form the functional polymer, wherein:
the first and second polymer pre-cursor materials are reactive to produce a polymer material upon mixing in which the material that releases the pest repellent odor is dispersed.

16. The method of claim 15, wherein curing the mixture comprises applying an external stimulus to the mixture.

17. The method of claim 15, wherein the external stimulus comprises at least one of heat, light, or a mechanical stress.

18. The method of claim 15, wherein the curing includes applying UV radiation, heat, or supplying air flow to the mixture.

19. The method of claim 15, further comprising applying the mixture to a mold to shape the mixture.

20. The method of claim 15, further comprising applying an adhesive layer to a surface of the repellent buffer.
